(19) United States
(12) Patent Application Publication
(10) Pub. No.: US 2023/0010136 A1
(43) Pub. Date: Jan. 12, 2023

(54) SYSTEM FOR CONTROLLING HYDROGEN COMBUSTION IN A HYDROGEN INTERNAL COMBUSTION ENGINE

(71) Applicant: VOLVO TRUCK CORPORATION, Goteborg (SE)

(72) Inventors: Jean-Marc NEVEU, St Priest (FR); Lionel SIMON, Lyon (FR)

(73) Assignee: VOLVO TRUCK CORPORATION, Goteborg (SE)

(21) Appl. No.: 17/810,739

(22) Filed: Jul. 5, 2022

(30) Foreign Application Priority Data
Jul. 6, 2021 (EP) 21184042.6

(51) Int. Cl. F02M 25/022; F02M 25/03; F02M 25/028; F02M 21/02

(52) U.S. Cl. CPC F02M 25/0222; F02M 25/0224; F02M 25/03; F02M 25/028; F02M 21/0206

(57) ABSTRACT

A hydrogen internal combustion engine system includes a combustion chamber connected to a hydrogen intake system, an air intake system and a water intake system for controlling hydrogen combustion, characterized in that the water injection system comprises an exhaust gas collector connected to an exhaust water condenser configured to condense at least a part of water contained in the exhaust gases.

### TECHNICAL FIELD

The invention relates to a system for controlling hydrogen combustion in an internal combustion engine using hydrogen as fuel, a vehicle comprising said system for controlling hydrogen combustion, and a method for controlling hydrogen combustion in a hydrogen internal combustion engine.

The invention can be applied in heavy-duty vehicles, such as trucks, buses and construction equipment. Although the invention will be described with respect to a heavy-duty vehicle, the invention is not restricted to this particular vehicle, but may also be used in other vehicles such as passenger vehicles

### BACKGROUND

Internal combustion engines operate by way of burning a fuel such as diesel or gasoline, in the presence of an oxidant inside a combustion chamber. Therefore, the fuel is transformed into other chemical species or combustion products, such as carbon dioxide (CO₂), water (H₂O) and byproducts such as nitrogen oxides (NOx). Moreover, mechanical and thermal energy are produced. The chemical species or combustion products emitted are released as exhausts gases. In order to reduce NOx emissions, aftertreatment of the exhausts gases are necessary.

The vehicle industry is striving to reduce CO₂ and byproducts emissions. For this purpose, various alternatives to diesel and gasoline have been developed for energizing vehicles. One such alternative is the use of hydrogen as fuel. The chemical energy of the hydrogen reacting with air may be converted into mechanical energy in order to propel the vehicle.

More precisely, hydrogen and air are introduced separately, through intake ports, into the combustion chamber of the internal combustion engine. The chemical reaction mostly produce H₂O at high-temperature and high-pressure. Exhaust gases are released through an exhaust port.

However, the use of hydrogen as a fuel inside a combustion engine present several issues. Hydrogen burns very easily, very fast and at high temperature. Therefore, ignition energy is very low and can induce abnormal combustion, like autoignition and knock, but also backfire from the combustion chamber to the intake ports.

To mitigate these main issues, it is known to operated under extremely lean conditions at air ratios far higher than λ=2 over a wide power range, so the level of NOx emissions is negligible. Even the crude exhaust has significantly lower concentrations of NOx in such a hydrogen-based operation in comparison with emissions of a hydrocarbon-based process following aftertreatment of the exhaust gases. Only if a relatively high power output is required it is necessary to make the fuel-air mixture richer in the range of 1≤λ≤2, which then is associated with a drastic increase in NOx emissions and thus the need for aftertreatment of the exhaust gas. However, this solution is costly.

Another solution is to dilute hydrogen with exhaust gas using a so called exhaust gas recirculation (EGR) unit. But it is not easy to have a sufficient amount of EGR because of the risk of water condensation when cooling and the low enthalpy of the exhaust gases to drive the internal combustion engine. In addition, EGR requires an exhaust gas pumping system which reduces the overall efficiency of the internal combustion engine.

Another solution is to dilute hydrogen with water in liquid phase, in order to lower the temperature of the combustion products as well as the temperature of overheated parts. This solution avoid implementing an exhaust gas pumping system in the internal combustion engine. The water is instantly vaporized to steam by igniting hydrogen gas. In addition, this solution allows decreasing boost efforts by working on lower dilution than with EGR.

To that purpose, a water intake system comprising a water tank connected to the internal combustion engine can be implemented. The water tank has to be filled with water by a vehicle user.

There is room for improvement so that a user does not have to refill a water tank regularly.

### SUMMARY

An object of the invention is to provide a system for controlling hydrogen combustion in a hydrogen internal combustion engine, that solves at least the previous problem of the prior art.

By the provision of a hydrogen internal combustion engine system which comprises an exhaust gas collector connected to an exhaust water condenser configured to condense at least a part of water contained in the exhaust gases, water produced by the combustion of hydrogen is reused which save water consumption. Moreover, a user does not need to regularly fill a water tank.

According to one embodiment, the exhaust water condenser is a heat exchanger comprising a cooling source comprising outside air and/or engine coolant.

According to one embodiment, the exhaust water condenser is configured to condense water from exhaust gases and to cool air for air intake into the combustion chamber. Hereby, the hydrogen internal combustion engine system comprises only one heat exchanger.

According to one embodiment, the exhaust gas collector is connected to an outside air collector in order to mix exhaust gas and outside air. Hereby, the exhaust gases collected are cooled before entering into the heat exchanger.

According to one embodiment, the hydrogen internal combustion engine system comprises an exhaust aftertreatment system (EATS) and the exhaust gas collector (30) is configured to collect exhaust gases after the EATS. Therefore, no filter is needed to remove NOx or other pollutants from the collected exhaust gases.

According to a further embodiment, the hydrogen internal combustion engine system comprises an exhaust aftertreatment system (EATS) and the exhaust gas collector is configured to collect exhaust gases before the EATS.

According to one embodiment, the hydrogen internal combustion engine system comprises a turbocharger for exhaust gases, and the exhaust gas collector is configured to collect exhaust gases before and/or after the turbocharger.

According to one embodiment, the water intake system comprises a water pump.

According to a further embodiment, the water intake system is configured to use pressure delta between the exhaust gas collector and the water injector.

According to one embodiment, the water intake system comprises a water tank connected to the exhaust water condenser and to the water injector.

According to one embodiment, the water intake system comprises a filter configured to remove pollutants such as carbon or particulate generated from hydrogen combustion.

According to one embodiment, the water injector is connected to the combustion chamber in order to provide a direct injection of water.

According to one embodiment, the water injector is connected to an admission pipe in order to provide an indirect injection of water.

According to one embodiment, the water intake system comprises valves for controlling water condensation, and an electronic valve control system.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a schematic view of a hydrogen internal combustion engine system according to a first embodiment,

FIG. 2 is a schematic view of a hydrogen internal combustion engine system according to a second embodiment, and

FIG. 3 is a schematic view of a hydrogen internal combustion engine system according to a third embodiment.

### DETAILED DESCRIPTION OF EMBODIMENTS OF THE INVENTION

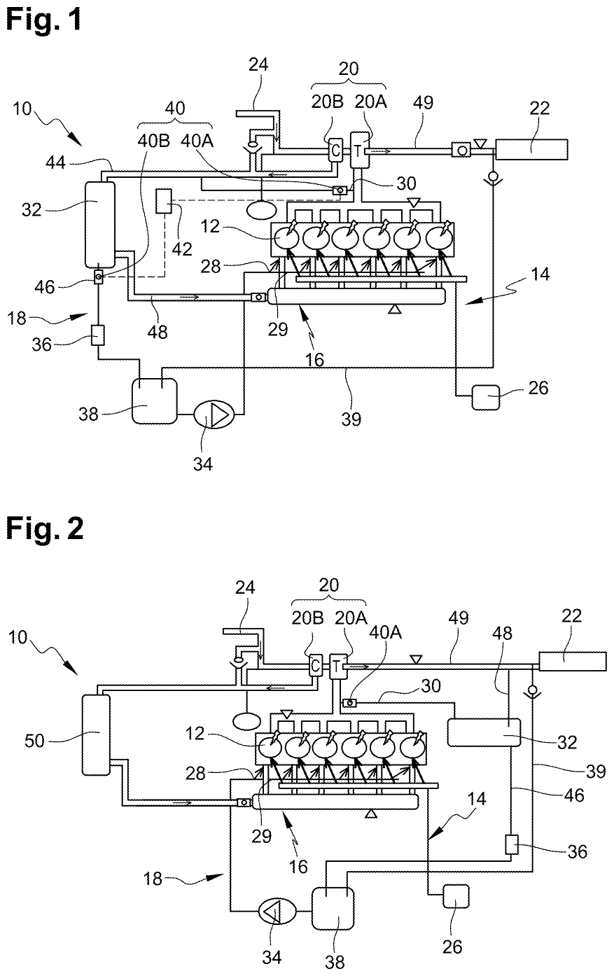

FIGS. 1 to 3 show a hydrogen internal combustion engine system 10 comprising at least one combustion chamber 12 connected to a hydrogen intake system 14, an air intake system 16 and a water intake system 18 for controlling hydrogen combustion.

The hydrogen internal combustion engine system can comprise a turbocharger 20 for exhaust gases. The turbocharger 20 can comprise a turbine 20A and an air compressor 20B. The turbocharger 20 can be used for compression of outside air that is supplied to combustion chamber 12 through the air intake system 16. The turbocharger 20 can be connected to an Exhaust AfterTreatment System (EATS) 22 configured to remove pollutant such as NOx from the exhaust gases.

The air intake system 16 can be connected to an outside air collector 24 and the hydrogen intake system 14 can be connected to a hydrogen tank 26.

The water intake system 18 comprises an exhaust gas collector 30 connected to an exhaust water condenser 32. The water intake system 18 can comprise at least one water injector 28 configured to inject water directly into the combustion chamber 12 or indirectly through an admission pipe 29.

The exhaust water condenser 32 is configured to condense at least a part of water contained in the exhaust gases. For instance, the exhaust gas condenser 32 is configured to condense one ninth of water produced in the exhaust gases. The exhaust water condenser 32 is a heat exchanger comprising a cooling source. The cooling source can be outside air and/or engine coolant.

The water intake system 18 can comprise a water pump 34. In alternative, the water intake system 18 can be configured to use pressure delta between the exhaust gas collector 30 and the water injector 28.

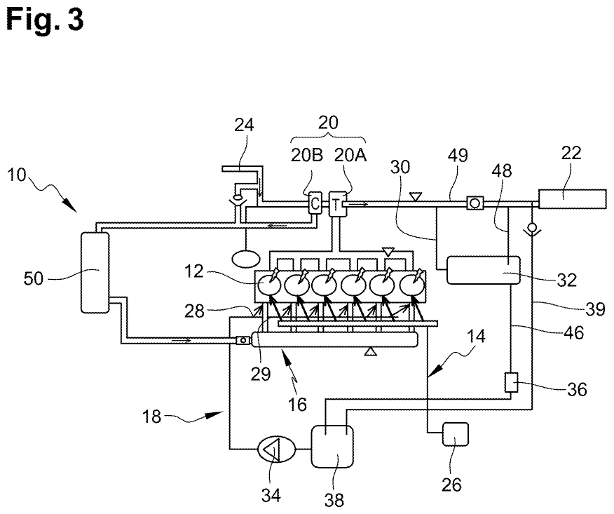

The exhaust gas collector 30 can be configured to collect exhaust gases before the EATS 22. More precisely, the exhaust gas collector 30 can be configured to collect exhaust gases before and/or after the turbocharger 20. For instance, as illustrated in FIG. 1, the exhaust gas collector 30 is configured to collect exhaust gases before the turbocharger 20. As illustrated in FIG. 3, the exhaust gas collector 30 is configured to collect exhaust gases after the turbocharger 20. As illustrated in FIG. 2, the exhaust gas collector 30 is configured to collect exhaust gases before and after the turbocharger 20.

The water intake system 18 can comprise a filter 36 configured to remove pollutants such as carbon or particulate generated from hydrogen combustion. The filter 36 can be disposed after the water exhaust condenser 32.

In a non-represented alternative, the exhaust gas collector 30 can be configured to collect exhaust gases after the EATS 22. Therefore, no filter is needed to remove pollutants such as carbon or particulate generated from hydrogen combustion.

The water intake system 18 can comprise a water tank 38 connected to the exhaust water condenser 32 and to the water injector 28. The water tank 38 is a water reserve which allows not to have continuous condensation. For instance, the water tank 38 has a volume of 50 L. Therefore, the water tank 38 enables to control the combustion of 30 to 100 kg of hydrogen into the combustion chamber according to driving cycle. The water tank 38 can be connected to a water tank venting line 39 configured to enable air to be exhausted from the water tank as it is filled with condensed exhaust water. The water tank venting line can be connected to the EATS.

The water intake system 18 can comprise valves 40 for controlling water condensation, such as an exhaust gas valve 40A and/or a water condensed valve 40B. The exhaust gas valve 40A enables to create a pressure drop to drive exhaust gases through the exhaust water condenser 32. The water intake system 18 can comprise an electronic valve control system 42 configured to control the valves 40, as illustrated in FIG. 1.

If the exhaust gas collector 30 is configured to collect exhaust gases before the EATS 22 and after the turbocharger 20, no exhaust gas valve 40A is needed, as represented un FIG. 3.

The water intake system 18 can comprise pressure sensors (not represented).

According to a first embodiment, as illustrated in FIG. 1, the exhaust water condenser 32 is a heat exchanger configured to condense water from exhaust gases and configured to cool outside air configured to be injected into the at least one combustion chamber 12 through the air intake system 16. Hereby, the hydrogen internal combustion engine system 10 comprises only one heat exchanger.

The exhaust gas collector 30 can be connected to the outside air collector 24 in order to mix exhaust gas and outside air. Hereby, the exhaust gases collected are cooled by the outside air before entering into the exhaust water condenser 32 through an inlet pipe 44.

The exhaust water condenser 32 can comprise a water condensed outlet pipe 46 and an exhaust gases outlet pipe 48. The water condensed outlet pipe 46 can be connected to the water injector 28. The exhaust gases outlet pipe 48 can be connected to the air intake system 16.

Water condensation is carried out preferably when there is a favourable thermal balance. That is to say, when there is enough air to cool the hydrogen internal combustion engine system 10 and condense the water.

In this first embodiment, exhaust gases are collected before the turbocharger 20. The back pressure generated by the turbocharger 20 enables to drive easily the exhaust gases. The exhaust gases can be mixed with outside air in the inlet pipe 44 configured to enter into the exhaust water condenser 32. The exhaust gases are cooled in the exhaust water condenser 32 and exhaust water is condensed. Condensed exhaust water can then be driven to the at least one water injector 28 or to the admission pipe 29, through the water condensed outlet pipe 46. Cooled air and cooled exhaust gases are driven to the air intake system 16 through the exhaust gases outlet pipe 48.

More precisely, condensed exhaust water can be driven to the water tank 38 through the water condensed outlet pipe 46. Condensed exhaust water can be filtered before entering into the water tank 38.

As the water tank is filled with condensed exhaust water, the water tank venting line 39 enable air to be exhausted from the water tank 38.

According to a second embodiment, as illustrated in FIGS. 2 and 3, the exhaust water condenser 32 is a heat exchanger configured to condense water from exhaust gases, and the hydrogen internal combustion engine system 10 can comprise another heat exchanger 50 configured to cool outside air configured to be injected into the at least one combustion chamber 12 through the air intake system 16.

The exhaust gas collector 30 can be connected to the exhaust water condenser 32.

As in the first embodiment, the exhaust water condenser 32 can comprise a water condensed outlet pipe 46 and an exhaust gases outlet pipe 48.

The water condensed outlet pipe 46 can be connected to the water injector 28. The exhaust gases outlet pipe 48 can be connected to an exhaust gases pipe 49 configured to drive exhaust gases outside of the vehicle.

As illustrated in FIG. 2, exhaust gases can be collected before the turbocharger 20 and driven to the exhaust water condenser 32. The exhaust gases are cooled in the exhaust water condenser 32 and exhaust water is condensed. Condensed exhaust water can then be driven to the at least one water injector 28 or to the admission pipe 29, through the water condensed outlet pipe 46.

More precisely, condensed exhaust water can be driven to the water tank 38 through the water condensed outlet pipe 46. Condensed exhaust water can be filtered before entering into the water tank 38.

As the water tank is filled with condensed exhaust water, the water tank venting line 39 enable air to be exhausted from the water tank 38.

As illustrated in FIG. 3, exhaust gases can be collected after the turbocharger 20 and driven to the exhaust water condenser 32. The exhaust gases are cooled in the exhaust water condenser 32 and exhaust water is condensed. Condensed exhaust water can then be driven to the at least one water injector 28 or to the admission pipe 29, through the water condensed outlet pipe 46.

More precisely, condensed exhaust water can be driven to the water tank 38 through the water condensed outlet pipe 46. Condensed exhaust water can be filtered before entering into the water tank 38.

As the water tank is filled with condensed exhaust water, the water tank venting line 39 enable air to be exhausted from the water tank 38.

It is to be understood that the present invention is not limited to the embodiments described above and illustrated in the drawings; rather, the skilled person will recognize that many changes and modifications may be made within the scope of the appended claims.

1. A hydrogen internal combustion engine system comprising a combustion chamber connected to a hydrogen intake system, an air intake system and a water intake system for controlling hydrogen combustion, characterized in that the water intake system comprises an exhaust gas collector connected to an exhaust water condenser configured to condense at least a part of water contained in the exhaust gases.

2. A hydrogen internal combustion engine system according to claim 1, characterized in that the exhaust water condenser is configured to condense water from exhaust gases and to cool air for air intake into the combustion chamber.

3. A hydrogen internal combustion engine system according to claim 2, characterized in that the exhaust gas collector is connected to an outside air collector in order to mix exhaust gas and outside air.

4. A hydrogen internal combustion engine system according to claim 1, characterized in that it comprises an exhaust aftertreatment system and the exhaust gas collector is configured to collect exhaust gases after the exhaust aftertreatment system.

5. A hydrogen internal combustion engine system according to claim 1, characterized in that it comprises an exhaust aftertreatment system and the exhaust gas collector is configured to collect exhaust gases before an the exhaust aftertreatment system.

6. A hydrogen internal combustion engine system according to claim 5, characterized in that it comprises a turbocharger for exhaust gases and in that the exhaust gas collector is configured to collect exhaust gases before and/or after the turbocharger.

7. A hydrogen internal combustion engine system according to claim 1, characterized in that the water intake system comprises a water pump.

8. A hydrogen internal combustion engine system according to claim 1, characterized in that the water intake system is configured to use pressure delta between the exhaust gas collector and the water injector.

9. A hydrogen internal combustion engine system according to claim 1, characterized in that the water intake system comprises a water tank connected to the exhaust water condenser and to the water injector.

10. A hydrogen internal combustion engine system according to claim 1, characterized in that the water intake system comprises a filter configured to remove pollutants such as carbon or particulate generated from hydrogen combustion.

11. A hydrogen internal combustion engine system according to claim 1, characterized in that the water injector is connected to the combustion chamber in order to provide a direct injection of water.

12. A hydrogen internal combustion engine system according to claim 1, characterized in that the water injector is connected to an admission pipe in order to provide an indirect injection of water.

13. A hydrogen internal combustion engine system according to claim 1, characterized in that the water intake system comprises valves for controlling water condensation, and an electronic valve control system.

14. A vehicle comprising a hydrogen internal combustion engine system according to claim 1.

15. A method for controlling hydrogen combustion in a hydrogen internal combustion engine system according to claim 1 characterized by the steps of:
collecting exhaust gases via the exhaust gas collector;
condensing water from the exhaust gases via the exhaust water condenser.
